(19) United States
(12) Patent Application Publication
(10) Pub. No.: US 2018/0171784 A1
(43) Pub. Date: Jun. 21, 2018

(54) Toroidal System and Method for Communicating in a Downhole Environment

(71) Applicant: Halliburton Energy Services, Inc., Houston, TX (US)

(72) Inventor: Mark W. Roberson, Cary, NC (US)

(73) Assignee: Halliburton Energy Services, Inc., Houston, TX (US)

(21) Appl. No.: 15/744,052

(22) PCT Filed: Aug. 12, 2015
(86) PCT No.: PCT/US2015/044797

§ 371 Date: Jan. 11, 2018

(51) Int. Cl. E21B 47/12; E21B 47/01; E21B 17/00

(52) U.S. Cl. CPC E21B 47/122; G01V 11/002; E21B 17/003; E21B 47/01

(57) ABSTRACT

A communication assembly is described that, when placed along a string casing in a wellbore, may be used to transmit data along a pipe string from the wellbore to, for example, the surface of the well. The assembly includes toroidal transmission coil wrapped around an insulator core to enhancing the signal and improving data transmission.

### BACKGROUND

Natural resources such as gas, oil, and water residing in a subterranean formation or zone are usually recovered by drilling a wellbore into the subterranean formation. Potentially, during the drilling process, a string of pipe (e.g., casing) is run in the wellbore and cemented in place. Cementing is typically performed whereby a cement slurry is placed in the annulus outside the casing and permitted to set into a hard mass (i.e., sheath) to thereby attach the string of pipe to the walls of the wellbore and seal the annulus.

In the performance of such a cementing operation, or in the performance of one or more other wellbore operations (e.g., a drilling operation, a stimulation operation, a completion operation, a fluid-loss control operation, production, or combinations thereof), it may be desirable to obtain data from within the wellbore, for example, data related to the conditions within the wellbore or data related to the operation or performance of downhole tools positioned within the wellbore.

Such data may include geology, rate of rock penetration, inclination, azimuth, fluid composition, temperature, and pressure, among others. Special downhole assemblies have been developed to monitor subsurface conditions. These assemblies are generally referred to as Logging While Drilling (LWD) or Measurement While Drilling (MWD) assemblies. LWD and MWD assemblies can be carried by downhole tools or any other apparatus that is placed downhole, and are able to store or transmit information about subsurface conditions for review by drilling or production operators at the surface.

A variety of technologies have been proposed or developed for downhole communications using LWD or MWD. In a basic form, MWD and LWD assemblies can store information in a processor having memory. The processor can be retrieved, and the information downloaded, later, when the downhole tool is removed from the wellbore.

Several real time data telemetry systems have also been proposed. Some involve the use of physical cable such as a fiber optic cable that is secured to the casing string. The cable may be secured to either the inner or outer diameter of the casing string. The cable provides a hard wire connection that allows for real time transmission of data and the immediate evaluation of subsurface conditions. Further, these cables allow for high data transmission rates and the delivery of electrical power directly to downhole sensors. As an alternative to such a wired system, nodes have been placed along a casing string to utilize near-field communications (NFC), to communicate one or more signals between nodes and up the casing string to the surface. The node-to-node communication allows transmission of data up the wellbore. The use of radiofrequency signals has also been suggested.

These systems all require data to be transmitted over a long distance through multiple nodes. The data signal that reaches the surface is only as good as the signal that can be passed between nodes. Thus, a need exists for a data transmission system that can transmit data between communication nodes.

### BRIEF DESCRIPTION OF THE DRAWINGS

FIG. 1 illustrates one embodiment of an oil rig and wellbore; and

FIG. 2 is a cut away view of a casing string and one embodiment of toroidal coil communication assemblies.

### DETAILED DESCRIPTION

The following discussion is directed to various embodiments of the invention. The drawing figures are not necessarily to scale. Certain features of the embodiments may be shown exaggerated in scale or in somewhat schematic form and some details of conventional elements may not be shown in the interest of clarity and conciseness. Although one or more of these embodiments may be preferred, the embodiments disclosed should not be interpreted, or otherwise used, as limiting the scope of the disclosure, including the claims. It is to be fully recognized that the different teachings of the embodiments discussed below may be employed separately or in any suitable combination to produce desired results. In addition, one skilled in the art will understand that the following description has broad application, and the discussion of any embodiment is meant only to be exemplary of that embodiment, and not intended to intimate that the scope of the disclosure, including the claims, is limited to that embodiment.

Certain terms are used throughout the following description and claims to refer to particular features or components. As one skilled in the art will appreciate, different persons may refer to the same feature or component by different names. This document does not intend to distinguish between components or features that differ in name but not structure or function.

In the following discussion and in the claims, the terms “including” and “comprising” are used in an open-ended fashion, and thus should be interpreted to mean “including, but not limited to . . . The use of “top,” “bottom,” “above,” “below,” and variations of these terms is made for convenience, but does not require any particular orientation of the components.

Unless otherwise specified, use of the terms “up,” “upper,” “upward,” “up-hole,” “upstream,” or other like terms shall be construed as generally from the formation toward the surface or toward the surface of a body of water; likewise, use of “down,” “lower,” “downward,” “down-hole,” “downstream,” or other like terms shall be construed as generally into the formation away from the surface or away from the surface of a body of water, regardless of the wellbore orientation. Use of any one or more of the foregoing terms shall not be construed as denoting positions along a perfectly vertical axis.

As used herein, the term “well” may be used interchangeably with the term “wellbore.”

Described herein are a system and method for communicating along a pipe string in a subterranean formation. Communication along the pipe string is accomplished using a communication system made up of a number of toroidal coil communication assemblies. The toroidal coil communication assemblies are in spaced locations along a pipe string between a signal to be transmitted along the pipe string, e.g., from a sensor, and a receiver for the signal. While the discussion may be in terms of signals being transmitted to the surface from a subsurface location, the receiver may be located anywhere within the wellbore, for example, intermediate the sensor and the surface or below the sensor.

The toroidal coil communication assemblies comprise a toroidal transmission coil and an insulating core that enhances the passage of a signal between the toroidal coil communication assemblies. A toroidal transmission coil is a donut shaped coil wrapped around a core. The cores are insulting cores, for example, glass or polymeric insulating materials.

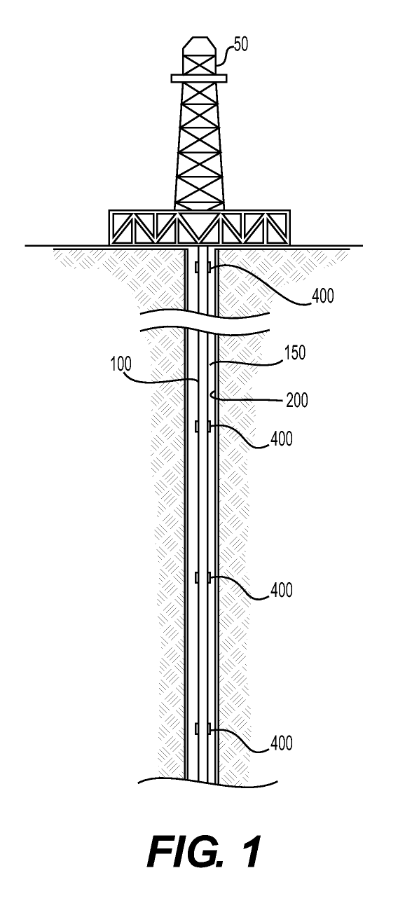

FIG. 1 exemplifies a rig 50 and a wellbore 200. According to the embodiment shown, a casing string 100 extends the length of the wellbore 200. An annulus 150 is created between the casing string 100 and the wellbore 200. Toroidal coil communication assemblies 400 are placed at spaced locations along the casing string 100 in the wellbore 200. The coil communication assemblies 500 are configured to be attached to the exterior of the casing string 100. Any suitable attachment method may be used.

In one embodiment, the toroidal coil communication assemblies 400 may be used to transmit data along the casing string to the surface of the wellbore 200. According to another embodiment, toroidal coil communication assemblies 400 send and receive electromagnetic signals from adjacent toroidal coil communication assemblies 400. The signal transmission moves either up or down the casing string 100. According to yet another embodiment, the signal can be transmitted from an LWD or MWD assembly, along the casing string 100 up to the surface of the wellbore 200, or downward to an alternate receiver. While the invention will be explained with reference to LWD and MWD assemblies, the signals that may be transmitted via this communication system can include data from other downhole tools or other sensors that are located in the wellbore 200.

The toroidal coil communication assemblies 400 may be at spaced intervals along the casing string. The distance between assemblies is from about 2 to about 100 meters, for example, from about 10 to about 50 meters, for example, from about 10 to about 30 meters, for example, from about 15 to about 30 meters. According to one embodiment, the coil communication assemblies may be spaced in a manner that creates some redundancy thereby allowing for a number of faulty assemblies within the communication system, without loss of communication. According to another embodiment, the coil communication assemblies may be placed at inconsistent or staggered lengths, for example, 10 meters between assemblies, followed by 20 meters between assemblies, and then maybe 30 meters between assemblies. Alternatively, the assemblies may be staggered inconsistently, for example, 10 meters between assemblies, followed by 30 meters between assemblies, followed by 10 meters between assemblies, followed by 20 meters between assemblies, or any suitable combination of distances.

While the embodiments described relate to casing strings, the toroidal coil communication assemblies 400 can be used to transmit signals along any pipe string, for example, a drill pipe, a casing string, a production tubing, coiled tubing, or injection tubing. The communication system can be used to transmit along a vertical axis, a horizontal axis or any other axis or well direction.

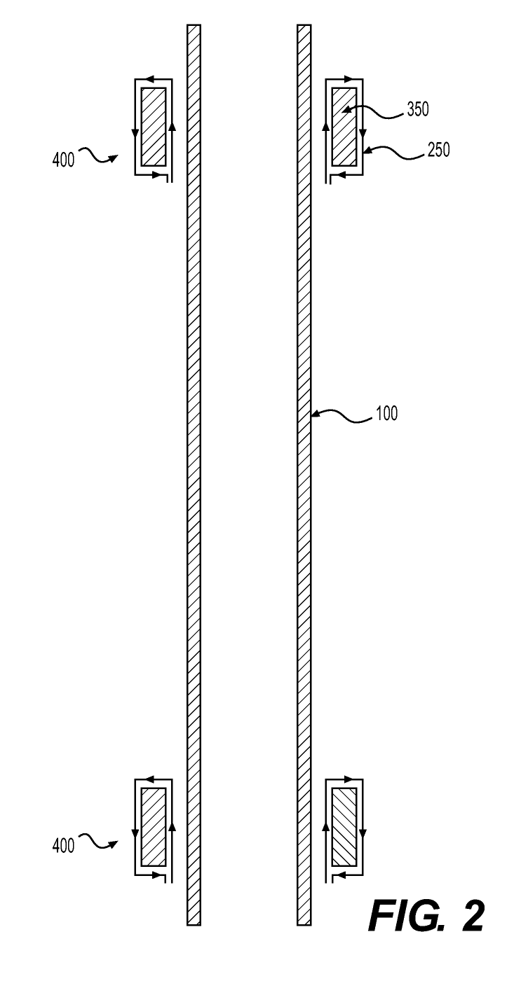

According to one embodiment seen in FIG. 2, the toroidal coil communication assemblies 400 comprise an insulating core 350 and a toroidal transmission coil 250 that is wound around the core 350. The arrows as shown in FIG. 2 represent the flow of the electrical signal in the toroidal coil. The toroidal transmission coil 250 transmits electromagnetic data along the casing string 100.

The core that is located inside the toroidal transmission coil 250 can be an insulating core. The insulator core may have a conductivity of less than 1,000 Siemens/meter, for example less than about 100 S/m, for example, less than about 10 S/m, for example, less than about 2 S/m, for example, less than 1 S/m, for example, between 10⁻⁴ to 1 S/m. The insulator core material may be chosen from glass, including fiberglass, porcelain, including clay, quartz, alumina or feldspar, or polymeric materials, including, A,B.S., acetates, acrylics, nylons, polystyrenes, polyimides, fluoropolymers, polyamides, polyethyletherketones, PET, polycarbonates, polyesters, polyolefins, polyurethanes, PTFE, PVCs, polyphenyl sulfides, silicones, and composite polymers and combinations thereof. According to another embodiment, the insulator core material may be chosen from a combination of an insulator material with a magnetic material having a high relative permeability constant. Appropriate high permeability magnetic materials would be readily apparent to the skilled artisan. Such materials may include ferrite, steel, metallic alloys including for example, iron-nickel alloys, e.g., Mu-metal, cobalt-iron alloys, and other magnetic alloys, Metglas and combinations thereof. According to another embodiment, the insulator core material may be chosen from a combination of an insulator and a magnetically switchable material that has a large non-linear response coefficient. Such materials include pyroelectric materials, for example, tourmaline, gallium nitride, caesium nitrate, and polyvinyl flourides. The toroidal coil transmission wire 250 may be chosen from any art recognized wire, including but not limited to copper, aluminum, steel, silver, and alloys thereof.

The toroidal coil communication assemblies 400 can receive and convey information to the surface without storing the information. Likewise, the toroidal coil communication assemblies 400 can include one or more storage devices that may store and transmit data or that may store and hold data for later reading. The communication system may communicate with the surface of the wellbore 200 wirelessly. While not intended to be used in a wired system, the use of wiring, in whole or in part, is not outside the scope and spirit of these embodiments. Appropriate data storage and wired communication systems are well understood by the skilled artisan.

There is further described a method for communicating between a subsurface location and the surface of a well or between two locations within the wellbore 200. When a wellbore 200 has one or more sensors of LWD or MWD assemblies that can measure conditions in the wellbore 200, the communication system as described can be used to transmit that information to the surface of the well in real time. The sensor or LWD assembly, for instance, transmits the data signal to a first toroidal coil communication assembly 400 that is coupled to the exterior of the pipe string 100 using any suitable coupling method. The signal from the first toroidal coil communication assembly 400 will be transmitted to an adjoining communication assembly 400 regardless of direction, i.e. the signal can be transmitted up the pipe string or down the pipe string. According to one embodiment, a condition in the wellbore is sensed and the data is transmitted from a sensor to a proximate toroidal coil communication assembly 400. The signal may them be repeatedly transmitted to the adjacent toroidal coil communication assembly 400 until the signal reaches a receiver at the surface of the wellbore. Alternatively, for example, a condition has been sensed by a senor, e.g., condition of cement, the signal may be transmitted down the pipe string, for example, to communicate with a receiver that would, for example, instruct a downhole tool to dose a port. In the method as described the signal is generally transmitted to a receiver that either resides within the wellbore 200 or that is above the surface of the wellbore. Any suitable receiver can be used and appropriate receivers are well understood by the skilled artisan.

Transmission of the signal between the toroidal coil communication assemblies 400 is enhanced by locating an insulating core 350 within the windings of the toroidal transmission coil 250. The insulating core 350 minimized signal loss into the pipe string 100.

According to one embodiment, were the casing string 100 to be made of an appropriate material, for example, a non-metallic casing, the transmission coil 250 could be wrapped around the exterior of the casing string or embedded into the casing string. According to another embodiment, the insulator material 350 can be in the form of a coating which surrounds the wire of the transmission coil 250. Such a coated transmission wire 250 could be wrapped around the casing string or embedded in the casing string.

Although specific embodiments have been illustrated and described herein, it should be appreciated that any arrangement configured to achieve the same purpose may be substituted for the specific embodiments shown. This disclosure is intended to cover any and all adaptations or variations of various embodiments. Combinations of the above embodiments, and other embodiments not described herein, will be apparent to those of skill in the art upon reviewing the above description.

As used herein, “about” is meant to account for variations due to experimental error. All numerical measurements are understood to be modified by the word “about”, whether or not “about” is explicitly recited, unless specifically stated otherwise. Thus, for example, the statement “a distance of 10 meters,” is understood to mean “a distance of about 10 meters.”

Although specific embodiments have been illustrated and described herein, it should be appreciated that any arrangement configured to achieve the same purpose may be substituted for the specific embodiments shown. This disclosure is intended to cover any and all adaptations or variations of various embodiments. Combinations of the above embodiments, and other embodiments not described herein, will be apparent to those of skill in the art upon reviewing the above description.

What is claimed is;

1. A system for communicating from within a subterranean wellbore to the surface of the wellbore, comprising:
a pipe string located within a subterranean wellbore, the pipe string comprising an exterior;
a toroidal coil communication assembly at a location along the pipe string, the toroidal communication assembly comprising a toroidal transmission coil wrapped around an insulator core.

2. The system of claim 1, wherein the insulator core comprises a conductivity of less than 1,000 Siemens/meter,

3. The system of claim 1, wherein the insulator core comprises a conductivity of less than 10 Siemens/meter.

4. The system of claim 1, where the insulator core comprises a conductivity of less than 1 Siemens/meter.

5. The system of claim 1, wherein the pipe sting comprises a casing string.

6. The system of claim 1, wherein the toroidal coil transmission wire may be chosen from copper, aluminum, steel, silver, and alloys thereof.

7. The system of claim 1, further comprising more than one toroidal communication assembly at spaced locations along the pipe string.

8. The system of claim 1, wherein the transmission coil comprises a copper coil.

9. The system of claim 1, wherein the insulating core is chosen from one or more of glass, fiberglass, porcelain, clay, quartz, alumina, feldspar, polymeric materials, A.B.S., acetates, acrylics, nylons, polystyrenes, polyimides, fluoropolymers, polyamides, polyethyletherketones, PET, polycarbonates, polyesters, polyolefins, polyurethanes, PTFE, PVCs, polyphenyl sulfides, silicones, composite polymers and combinations thereof.

10. The system of claim 1, wherein the insulating core is chosen from a combined insulator and high permeability magnetic material.

11. The system of claim 1, wherein the insulating core is chosen from a combined insulator and magnetically switchable material that has a large non-linear response coefficient.

12. The system of claim 1, wherein the coil communication assembly is configured to receive data from a logging-while-drilling or measurement-while-drilling tool.

13. The system of claim 7, wherein the coil communication assemblies are spaced between about 10 meters and about 30 meters apart along the pipe string.

14. A method for communicating between two locations in a subterranean wellbore including a pipe string comprising:
sensing a condition of the wellbore;
transmitting a signal indicative of the sensed condition from a first toroidal communication assembly insulated from signal loss;
retransmitting the signal indicative of the sensed condition from at least one second toroidal communication assembly insulated from signal loss; and
receiving the transmitted signal at the spaced location.

15. The method of claim 14, wherein the toroidal communication assembly comprises a transmission coil wrapped around an insulator core.

16. The method of claim 15, wherein the pipe string is a casing string and the transmission coil is wrapped around the casing string in the wellbore.

17. The method of claim 14, wherein the at least one second toroidal communication assembly comprises multiple toroidal-communication-assemblies at spaced locations along a casing string.

18. The method of claim 17, wherein the multiple toroidal-communication-assemblies are spaced from between about 10 meters and between about 100 meters apart.

19. The method of claim 14, wherein the receiver is located at the surface of the wellbore.

20. The method of claim 14, wherein the receiver is location downhole from the sensor.

21. The method of claim 19, wherein the receiver operates one or more downhole tools.
